(19) United States
(12) Patent Application Publication
(10) Pub. No.: US 2006/0176895 A1
(43) Pub. Date: Aug. 10, 2006

(54) Data delivery pipeline optimized by cell-based data cascade technology

(76) Inventor: Yakov Kamen, Cupertino, CA (US)

Correspondence Address: Yakov Kamen, 19334 Greenwood Drive, Cupertino, CA, 95014, US

(21) Appl. No.: 11/052,498

(22) Filed: Feb. 7, 2005

(51) Int. Cl. H04L 12/28; H04J 3/04

(52) U.S. Cl. 370/431; 370/535

(57) ABSTRACT

A data delivery pipeline in accordance with the invention combines client-server and peer-to-peer solutions together. All data displaying entities are separated into cells. Each cell consists of retransmitting entities and servent entities. Servent entities receive data only from in-cell retransmitting entities or other in-cell entities. In one embodiment data is separated into main and control data. Main data is delivered from central server to the retransmitting entities. Control data is used for entities' communication with central servers, and some retransmitting entities.

### CROSS-REFERENCE TO RELATED APPLICATIONS

This application claims the benefit of provisional patent filed 2004 Feb. 6 by the present inventor

### FEDERALLY SPONSORED RESEARCH

Not applicable

### SEQUENCE LISTING OF PROGRAM

Not applicable

### BACKGROUND OF THE INVENTION

The present invention pertains to technology of data delivery in a heterogeneous network environment, particularly to the data delivery over peer-to-peer heterogeneous networks.

Although methods and solutions of video, imaging, audio, and textual data delivery are well established and known in the industry, choosing the cost-optimized data delivery method for a concrete system is a complex process. For instance, data can be delivered from central servers to client entities inside a single digital channel as a private component of the MPEG stream, inside a single analog or digital channel using vertical blanking interval (VBI), in a separate data delivery channel, spread inside multiple analog or/and digital channels, over the telephone line (POTS), over the Internet, over GSM/CDMA. Each method has its own advantages and disadvantages and none of the methods have been chosen as the ultimate standard.

Most existing data delivery systems operate as follows. First, data is transmitted from the central servers to the client displaying device (“CDD”) located on the user's premises using a single pre-defined method. A CDD may be for instance a generic PC, digital (personal) video recorder (DVR/PVR), set-top box (STB), cellular phone, or any combination of such devices. The CDD contains memory (and is in essence a dedicated computing device) so that the data can be stored for later transformation, parsing, and viewing. The data delivered to the CDD is recognized and downloaded first, and then is filtered and stored on the CDD. This data is frequently updated (periodically or non-periodically). A microprocessor within the CDD recognizes the data, parses, filters and stores it. Depending on the nature of the received data and capabilities of the CDD, transferred data can be displayed or used in the CDD's decision making processes.

The serious disadvantage of existing data delivery systems is that they are usually designed as centralized client-server systems or as completely decentralized peer-to-peer networks of CDD devices. In client-server systems the data provider absorbs all data transmission and server's maintenance fees. It can be expensive for the service provider. In peer-to-peer systems, the service provider's costs are minimal but in the general case customers (peers) have to absorb the data transmission costs. In addition, peer-to-peer architectures have potential security problems.

Examples 1 and 2 Below Illustrate the Above Problems.

Example 1. A centralized data delivery system allows all client display devices to download data using an 800 telephone access number. Each CDD simply dials a pre-defined 800 number at a predefined time and receives the necessary data. In such systems data delivery service providers are charged by Telco companies for each call.

Example 2. A peer-to-peer POTS-based data delivery system requires each client display device to receive data and immediately send it to another arbitrarily chosen client. If user is lucky his CDD will send data to another user's CDD for free. Such a data transmission is free when both clients are located in the same area code. Otherwise the user will be charged for all transmission time and it may be expensive.

The proposed invention solves the problems described above by creating systems that subdivide CDDs into groups or cells and use the peer-to-peer data exchange approach to transfer data inside each cell, and the client-server approach for a limited number of special CDDs.

### SUMMARY

A Data Delivery Pipeline in accordance with one embodiment of the invention is a special system consisting of central servers and client displaying devices (CDDs or entities) separated into special groups or cells. Each cell comprises a small subset of entities called retransmitters and a large subset of entities called servents. The invented system transmits data from central servers to retransmitters and then from retransmitters to servents. Servents exchange data inside the same cell.

In one embodiment of the invention, the system allows one to adjust the cell system's organization when the cost structure of data delivery changes.

In another embodiment of the invention, all data is separated into two categories: main data and control data. Main data is the data that had to be delivered to the cell elements. Control data is the data that facilitates main data delivery. A servent can exchange main data only with other in-cell elements (servents, and/or retransmitters). It can exchange control data with central data servers or out-of-cell retransmitters. A data retransmitter can exchange main and control data with in-cell elements, out-of-cell retransmitters, and central data servers.

### BRIEF DESCRIPTION OF THE DRAWINGS

FIG. 1 shows a Block Diagram of a Data Delivery System in Accordance with the present invention.

FIG. 2 shows a Block Diagram of the Data Delivery System that has main and control data separated

### DETAILED DESCRIPTION

This invention relates to a data delivery system that delivers information from central data servers (CDSs) to client displaying devices (CDDs or entities).

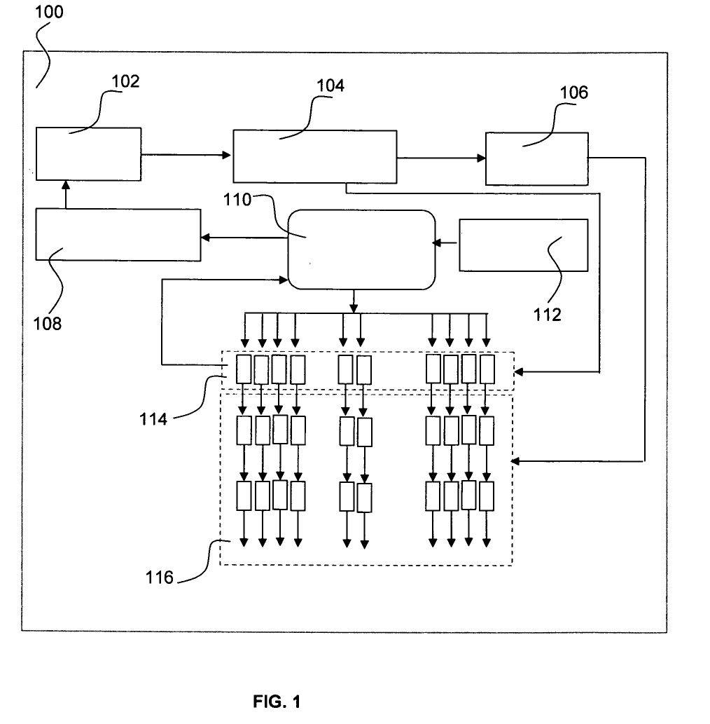

FIG. 1 describes a preferred embodiment 100 of the invention. According to this embodiment cells are created in the cell creation block 102. Cells are created to minimize the data delivery cost formula that in one embodiment can be defined as follows:

$${F}_{DDS} ( S ) = {\sum }_{i = 1}^{n} [ {\sum }_{j = 1}^{k ( i )} ( {C}_{d} ( {r}_{j} ) + {D}_{k} ( {r}_{j} ) ) + {\sum }_{j = 1}^{I ( i )} ( {E}_{d} ( {s}_{j} ) + {G}_{k} ( {s}_{j} ) ) ] , \qquad ( 1 )$$

where:

S—is the set of data exchange objects in the data delivery system;

n—is the number of cells;

k(i)—is the number of data retransmitters in the cell “i”;

l(i)—is the number of data servents in the cell “i”;

C_{d}(x)—is the cost of main data delivery for the retransmitter x;

Dₖ(x)—is the cost of control data delivery for the retransmitter x;

E_{d}(x)—is the cost of main data delivery for the servent x;

Gₖ(x)—is the cost of control data delivery for the servent x;

rⱼ—is the retransmitter “j”;

sⱼ—is the servent “j”.

In many cases control data delivery cost can be considered a constant number R for all retransmitters and a constant number T for all servents. In many practical cases cells can be designed such that E_{d}(x) is a constant: E_{d}(x)=E for all servents. For example, when in-cell elements are located in the same USA area code and connected via phone, then usually E=0.
For these cases formula (1) can be simplified to

$${F}_{DDS} ( S ) = {\sum }_{i = 1}^{n} [ {\sum }_{j = 1}^{k ( i )} ( {C}_{d} ( {r}_{j} ) ) + k ( i ) R + l ( i ) \times ( E + T ) ] . \qquad ( 2 )$$

When cells are created, block 104 assigns one or more entities of the cell as retransmitters. In one embodiment data retransmitters are assigned randomly (stochastic assignment). In another embodiment the assignment is static, or permanent. In yet another embodiment a static (permanent) assignment can be used for one group of data retransmitters and dynamic (stochastic) assignment can chosen for another group. Stochastic assignment increases security of the data downloading system but also increases the data delivery cost because of the inevitable expense of additional synchronization between servents and retransmitters. Static data retransmitters' assignment decreases synchronization cost but also decreases data delivery process security. The first output of block 104 is connected to the input block 106. The second output of block 104 is connected to the input of block 116.

When retransmitters are set, block 106 defines data servents' connection topology.

In one embodiment servents can be connected sequentially in a chain or in a mesh. Chain connections minimize “connectivity” time for each servent but increase overall data propagation time. Mesh connections decrease overall data propagation time but also increase the time of connection. In-cell servent connection topology can be optimized based on application-specific “data propagation/time on-line” trade offs.

In one embodiment cell organization can be changed using cell organization control block 108. The output of block 108 is connected to the input of block 102.

Central servers in block 110 transmit data to retransmitters 114. The first output of block 110 is connected to the input of block 108. The second output of block 110 is connected to the input of block 114.

The data organization management block 112 allows adjusting the central server's communication with retransmitters when it is needed. The output of block 112 is connected to the input of block 110.

The algorithm that outlines the preferred embodiment's operation is as follows:

The cell creation block 102 subdivides all CDDs into special cells based on minimum cost criteria (1) and (2).

The retransmitter assignment block 104 and servent organization block 106 subdivides the CDDs of each cell into retransmitting CDDs and servent CDDs. Retransmitting CDDs (or retransmitters) receive data directly from central servers or other retransmitters. Servent CDDs (or servents) receive data from in-cell servents or in-cell retransmitters. This analysis is provided at the original system installation, every time a block is updated, a new pipeline is added, or old pipeline is eliminated. Block 106 allows defining a mechanism of servents' data transmission.

When the cost of data transmission changes, block 108 receives control information from block 100 filtering and transferring it to block 102.

To provide the appropriate level of security, one can decide to change data organization using block 112.

Additional Embodiments.

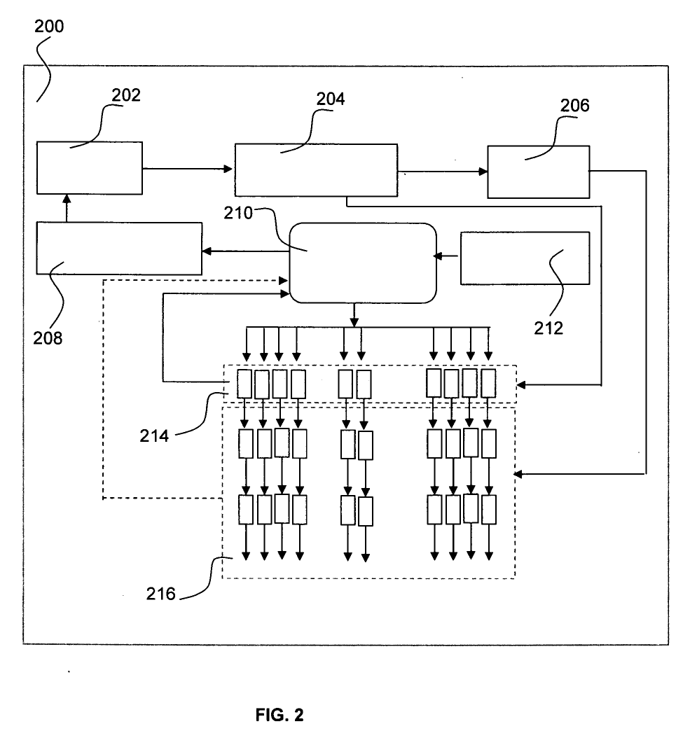

FIG. 2 describes another embodiment 200 of the invention. In this embodiment data is separated into two categories: main data and control data. Main data is the data that had to be delivered to the cell elements in blocks 214 and 216. Control data is the data that facilitates main data delivery. Servents in block 216 can exchange main data only with other in-cell elements' servents and/or in-cell retransmitters. At the same time they can exchange control data with central data servers from block 210 or out-of-cell retransmitters from block 214. Data retransmitters in block 214 can exchange main and control data with in-cell elements, out-of-cell retransmitters, and central data servers in block 210.

In one embodiment, the number of data categories can be more than 2.

Accordingly, the reader can see that the invented data delivery method and apparatus can be used to deliver data economically and securely. It allows such data delivery system to create new highly optimized data delivery pipelines by accurately creating CDD cells. Furthermore, the optimized data delivery pipeline:
permits hardware manufacturers to develop next generation products that may support new data delivery networks;
allows building worldwide solutions adapting to local transmission cost models.
   Although the description above contains much specificity, these should not be construed as limiting the scope of the invention but as merely providing illustrations of some presently preferred embodiment of this invention.

I claim:

1. A method of optimization of data delivery pipelines comprising:
subdivision of the data delivery pipeline entities into cells; and
a criterion for said entities subdivision; and assignment of each such data delivery pipeline entity as data retransmitter or data servent; and a criterion for such assignment; and transmission data from central servers to data retransmitters; and transmission data from some data retransmitters to other data retransmitters; and transmission data from some data retransmitters to some data servents of the same cell; and transmission data from some data servents to other data servents of the same cell.

2. The method of claim 1 wherein said cells generation is controlled by an adaptive control mean.

3. The method of claim 1 wherein said assignment of data delivery pipeline entities is controlled by an adaptive control mean.

4. The method of claim 1 wherein said data is subdivided into groups of main data and control data; and all data pipeline entities can exchange such control data with central servers or some data retransmitters.

5. The method of claim 4 wherein said cells generation is controlled by an adaptive control mean.

6. The method of claim 4 wherein said assignment of the data delivery pipeline entities is controlled by an adaptive control mean.

7. The method of claim 4 wherein said data subdivision into groups of main data and control data is controlled by an adaptive control mean.

8. An apparatus comprising:
data delivery pipelines; and said data delivery pipeline cell generation mean; and said data delivery pipeline retransmission and servent assignment mean; and said data delivery pipeline servent transmission organization mean; and said central server mean.

9. The apparatus of claim 8 wherein said pipeline cell generation mean is connected with a pipeline cell update mean to change said pipeline cell mean.

10. The apparatus of claim 8 wherein said pipeline retransmitter and servent assignment mean is connected with a pipeline retransmitter and servent assignment update mean to change said pipeline assignment mean.

11. The apparatus of claim 8 wherein said data delivery pipeline servent transmission organization mean is connected with said data delivery pipeline servent transmission organization update mean to change said data delivery pipeline servent transmission organization.

12. The apparatus of claim 8 wherein said data is subdivided into main and control data groups and said servent mean is connected with said central server mean.

13. The apparatus of claim 12 wherein said data subdivision mean is connected with a pipeline data subdivision update mean to change said data subdivision.
